(19) United States
(12) Patent Application Publication
(10) Pub. No.: US 2014/0004750 A1
(43) Pub. Date: Jan. 2, 2014

(54) ELECTRICAL PLUG TYPE CONNECTOR

(71) Applicant: Joachim Zapf, Limburgerhof (DE)

(72) Inventor: Joachim Zapf, Limburgerhof (DE)

(73) Assignee: TYCO ELECTRONICS AMP GMBH, Bensheim (DE)

(21) Appl. No.: 14/003,703

(22) PCT Filed: Mar. 7, 2012
(86) PCT No.: PCT/EP2012/053865

§ 371 Date: Sep. 6, 2013

(30) Foreign Application Priority Data
Mar. 9, 2011 (DE) 10 2011 005 301.8

(51) Int. Cl. H01R 13/04

(52) U.S. Cl. CPC H01R 13/04
USPC 439/660

(57) ABSTRACT

An electrical plug type connector comprises a housing of electrically insulating material and an electrically conductive first contact element for transmitting an electrical signal. The housing of the plug type connector has an encoding lug of electrically insulating material. An electrically conductive second contact element is further arranged in the encoding lug.

The invention relates to an electrical plug type connector according to the preamble of patent claim 1.

Electrical plug type connectors are known in many different configurations. Electrical plug type connectors generally have one or more electrical contacts which may be constructed, for example, as contact pins.

When arranging the contact elements in the electrical plug type connector, various auxiliary conditions must be taken into consideration. For example, in order to prevent undesirable electrical arcs and/or leakage currents between two contact elements of a plug type connector, fixed air gaps and leakage paths must be complied with. In plug type connectors which are provided to carry high voltages and/or high currents, it is further necessary to effectively prevent inadvertent contact of the electrical contact elements by a user of the plug type connector by means of appropriate structural measures.

It is further known to provide electrical plug type connectors with encoding lugs. Such encoding lugs serve to ensure that the electrical plug type connector provided with the encoding lug can be connected only to a suitable plug type connector counter-piece which is provided for that purpose. The electrical plug type connector is thereby prevented from inadvertently being engaged with an incorrect plug type connector counter-piece.

Experience has shown that it is occasionally necessary to change an already existing electrical plug type connector with a fixed structure and fixed geometric arrangement of the electrical contact elements in such a manner that another electrical contact element is added to the electrical plug type connector. This may be found to be difficult in particular with small electrical plug type connectors. To some extent, the addition of the additional electrical contact element is possible only by infringing one of the mentioned auxiliary conditions. For example, by adding the additional electrical contact element, a required minimum spacing between two adjacent electrical contact elements could fail to be achieved. The addition of another electrical contact element to an electrical plug type connector may, for example, be necessary in order to provide another electrical connection by means of which an electrical circuit, a controller or an ASIC can be verified, trained or programmed.

An object of the present invention is consequently to provide an improved electrical plug type connector. This object is achieved with an electrical plug type connector having the features of claim 1. Preferred developments are set out in the dependent claims.

An electrical plug type connector according to the invention comprises a housing of an electrically insulating material and an electrically conductive first contact element for transmitting an electrical signal. The housing of the plug type connector has an encoding lug comprising electrically insulating material. Furthermore, an electrically conductive second contact element is arranged in the encoding lug. Advantageously, the second contact element can then be used to verify, train or program an electrical circuit. Another advantage is that the second contact element uses the space of the electrical plug type connector provided for the encoding lug and therefore takes up no additional space.

The second contact element is preferably accessible from an insertion side of the plug type connector. Advantageously, the second contact element can then be contacted by a suitable plug type connector counter-piece.

In one embodiment of the electrical plug type connector, the first contact element is a metal contact pin. Advantageously, a plug type connector counter-piece which fits the electrical plug type connector may then be constructed as a socket.

It is advantageous for the second contact element to also be a metal contact pin. In this instance, the second contact element may advantageously also be contacted by means of a socket opening of a plug type connector counter-piece.

The second contact element is preferably provided to transmit a test, verification or programming signal. Advantageously, the electrical plug type connector can then provide a wider range of application possibilities compared with an electrical plug type connector without the second contact element.

In a development of the electrical plug type connector, it has a plurality of first contact elements.

In an additional development of the electrical plug type connector, the housing has a collar, the first contact element being arranged in a region of the housing defined by the collar. Advantageously, this collar protects the first contact element from damage. Furthermore, the collar may prevent inadvertent contact of the first contact element by a user of the electrical plug type connector.

It is advantageous for the encoding lug to be arranged in the region of the housing defined by the collar. Advantageously, the encoding lug prevents the electrical plug type connector from being engaged with an unsuitable plug type connector counter-piece.

In a particularly preferred manner, the encoding lug has a cylindrical shape with trapezoidal base faces, the longitudinal axis of the encoding lug being orientated parallel with an insertion direction of the plug type connector and the encoding lug being arranged in abutment with the collar. Advantageously, such a structure of the encoding lug has been found to be advantageous since it makes it easier to engage the electrical plug type connector with a suitable plug type connector counter-piece.

The invention is explained in greater detail below with reference to Figures, in which:

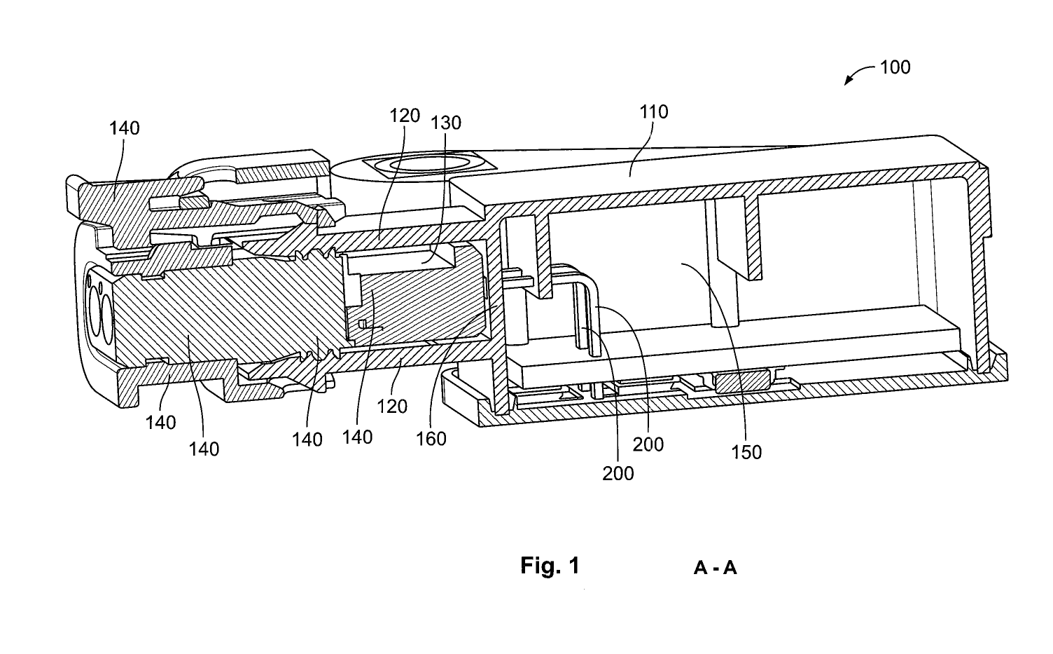

FIG. 1 is a sectioned view of an electrical plug type connector;

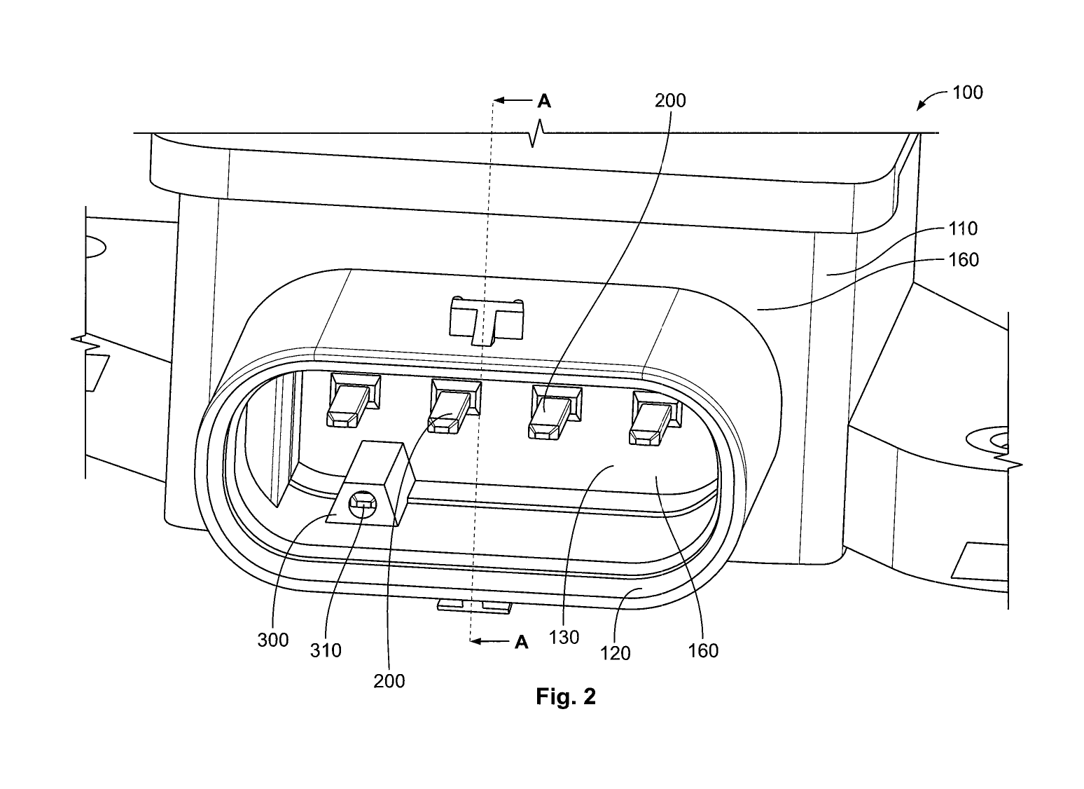

FIG. 2 is a plan view of the electrical plug type connector; and

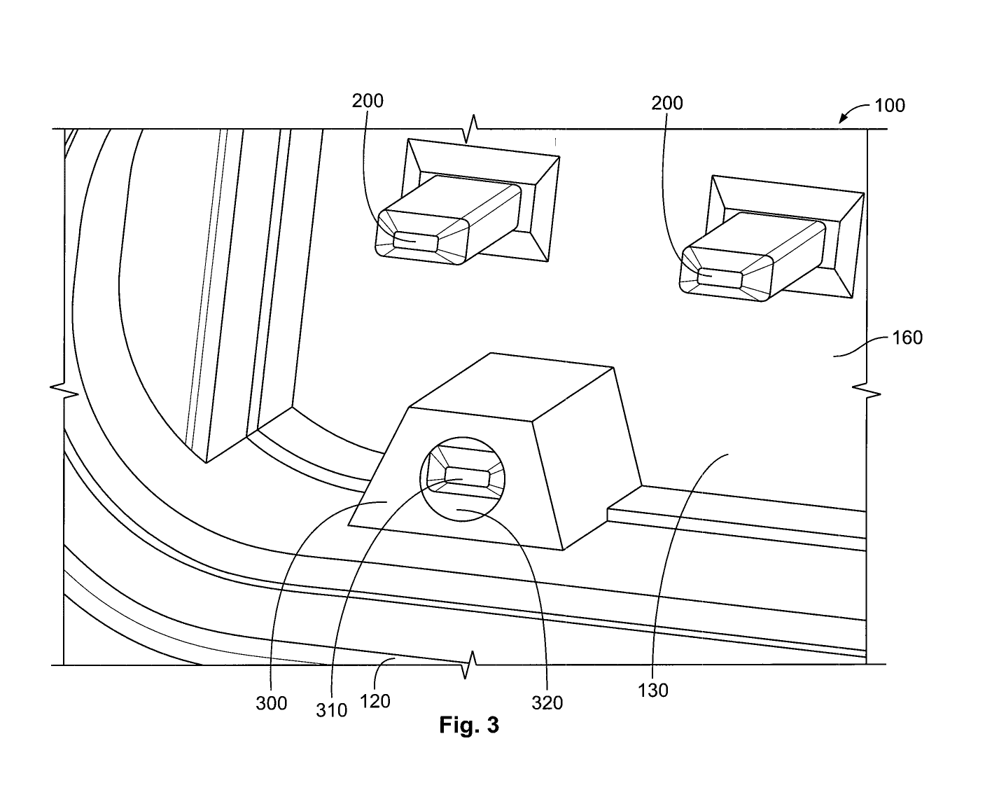

FIG. 3 shows a detail of the electrical plug type connector.

FIG. 1 is a sectioned illustration of an electrical plug type connector 100. The electrical plug type connector 100 is cut along the line of section AA indicated in FIG. 2. The electrical plug type connector 100 may, for example, be used in a motor vehicle.

The electrical plug type connector 100 has a housing 110. The housing 110 preferably comprises an electrically insulating material, for example of plastics material. The housing 110 has a hollow-cylindrical collar 120 which defines an insertion region 130 of the electrical plug type connector 100. One or more first electrical contact element(s) 200 extend(s) from a plug type connector inner space 150 which is at least partially surrounded by the housing 110 through a wall 160 to the insertion region 130. In the illustration of FIG. 1, two first contact elements 200 can be seen. The first electrical contact elements 200 comprise an electrically conductive material, preferably comprising a metal.

In the illustration of FIG. 1, other components 140 are arranged in the insertion region 130 of the electrical plug type connector 100. The other components 140 are insignificant for explaining the principle on which the electrical plug type connector 100 is based and will not be referred to below.

FIG. 2 is a plan view of the collar 120 of the housing 110 of the electrical plug type connector 100 and the insertion region 130 defined by the collar 120. It is possible to see that the collar 120 has the shape of a cylindrical cover which is arranged perpendicularly on the wall 160 of the housing 110.

In the insertion region 130 defined by the collar 120, four first electrical contact elements 200 are arranged. The first contact elements 200 extend from the plug type connector inner space 150 through the wall 160 of the housing 110 of the electrical plug type connector 100 into the insertion region 130. In the illustrated example, the first contact elements 200 are constructed as contact pins. However, it would also be possible to construct the first contact elements 200 as contact sleeves or in a different manner.

The first contact elements 200 extend perpendicularly from the wall 160 of the housing 110 and parallel with the longitudinal axis of the collar 120. The length of the collar 120 in the longitudinal direction is greater than the length of the portions of the first contact elements 200 arranged in the insertion region 130. Inadvertent contact of the first contact elements 200 by a user of the electrical plug type connector 100 is thereby prevented.

The first contact elements 200 have a regular arrangement in the insertion region 130. In the example illustrated, the first contact elements 200 are each arranged with the same mutual spacing along a straight line. However, it is also possible to have a different geometric arrangement of the first contact elements 200 in the insertion region 130.

In the insertion region 130 of the electrical plug type connector 100 defined by the collar 120, there is further provided an encoding lug 300. The encoding lug 300 serves to ensure that only a plug type connector counter-piece provided for that purpose can be inserted into the insertion region 130 of the electrical plug type connector 100. To this end, the electrical plug type connector counter-piece has a recess which is arranged in such a manner that, when the plug type connector counter-piece is engaged with the electrical plug type connector 100, it receives the encoding lug 300 of the electrical plug type connector 100.

The encoding lug 300 is constructed in a cylindrical manner in the illustrated example and has a trapezoidal base face. The longitudinal axis of the encoding lug 300 is orientated parallel with the longitudinal axis of the collar 120 and consequently also parallel with the first contact elements 200 and an insertion direction of the electrical plug type connector 100. A covering face of the cylindrical encoding lug 300 abuts the collar 120 of the electrical plug type connector 100. Preferably, the length of the encoding lug 300 in the longitudinal direction is smaller than the length of the collar 120. In a particularly preferred manner, the length of the encoding lug 300 corresponds to the length of the portions of the first contact elements 200 arranged in the insertion region 130.

FIG. 3 is a detailed view of the encoding lug 300 arranged in the insertion region 130 of the electrical plug type connector 100. In FIG. 3, it can be seen that the encoding lug 300 has a cylindrical opening 320 which extends through the encoding lug 300 parallel with the longitudinal axis of the encoding lug 300. A second electrical contact element 310 is arranged in the cylindrical opening 320 of the encoding lug 300. The second electrical contact element 310 consequently extends parallel with the first electrical contact elements 200 and extends in the same manner from the insertion region 130 through the wall 160 into the plug type connector inner space 150.

In the illustrated example, the second contact element 310 is constructed as a contact pin which is arranged in the cylindrical opening 320 of the encoding lug 300. However, the second contact element 310 could also be constructed as a contact sleeve or in a different manner.

The second contact element may be provided to transmit a test, verification or programming signal. Advantageously, the presence of the second contact element 310 does not increase the spatial requirement necessary for the insertion region 130. Since the encoding lug 300 must in any case be provided in the insertion region 130 of the electrical plug type connector 100, the arrangement of the second contact element 310 in the encoding lug 300 does not increase the spatial requirement of the electrical plug type connector 100.

1-9. (canceled)

10. Electrical plug type connector having a housing of electrically insulating material and having an electrically conductive first contact element for transmitting an electrical signal,
the housing of the plug type connector having an encoding lug of electrically insulating material,
wherein an electrically conductive second contact element is arranged in the encoding lug.

11. Electrical plug type connector according to claim 10, wherein the second contact element is accessible from an insertion side of the plug type connector.

12. Electrical plug type connector according to claim 10, wherein the first contact element is a metal contact pin.

13. Electrical plug type connector according to claim 10, wherein the second contact element is a metal contact pin.

14. Electrical plug type connector according to claim 10, wherein the second contact element is provided to transmit a test, verification or programming signal.

15. Electrical plug type connector according to claim 10, wherein the plug type connector has a plurality of first contact elements.

16. Electrical plug type connector according to claim 10, wherein the housing has a collar, the first contact element being arranged in a region of the housing defined by the collar.

17. Electrical plug type connector according to claim 16, wherein the encoding lug is arranged in the region of the housing defined by the collar.

18. Electrical plug type connector according to claim 16, wherein the encoding lug has a cylindrical shape with a trapezoidal base face,
the longitudinal axis of the encoding lug being orientated parallel with an insertion direction of the plug type connector,
the encoding lug being arranged in abutment with the collar.
